(19) United States
(12) Patent Application Publication
(10) Pub. No.: US 2016/0180736 A1
(43) Pub. Date: Jun. 23, 2016

(54) Executive Chef Education Structure

(71) Applicant: Alain Hadges, Westport, CT (US)

(72) Inventor: Alain Hadges, Westport, CT (US)

(21) Appl. No.: 14/581,891

(22) Filed: Dec. 23, 2014

(51) Int. Cl. G09B 19/00

(52) U.S. Cl. CPC G09B 19/00

(57) ABSTRACT

A new process created from existing separate and independent business and educational processes for the purpose of reducing the time required for an individual to acquire the experience needed for the position of Executive Chef. An educational structure is created between established food service industry businesses and an educational institution which runs the food service operations of the business through which trainees acquire the necessary experience for the position of Executive Chef by progression through sub-Chef and Chef positions of increasing responsibility leading to the position of Executive Chef.

### TECHNICAL FIELD AND APPLICABILITY OF THE INVENTION

This invention relates to the process of imparting education, training and experience to individuals. The present invention relates to culinary science educational programs, and specifically the process of imparting the experience required for the position of Executive Chef to an individual.

### DRAWINGS

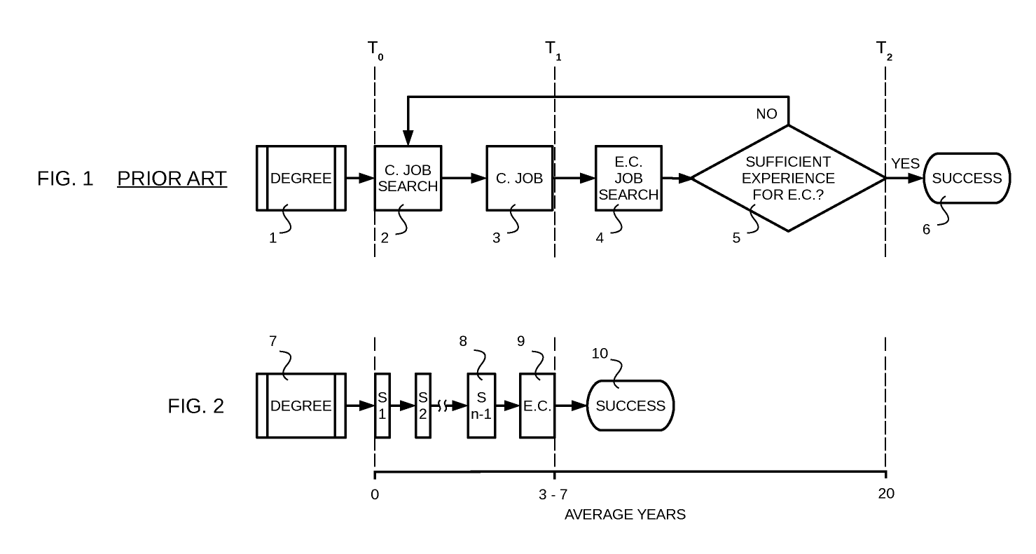

One sheet containing two drawings accompany this specification. The first drawing labeled “FIG. 1: Prior Art” shows the process of the prior art. The second drawing labeled “FIG. 2” shows the process of this invention. The process steps in each drawing are identified by numbers. To avoid duplication of numbers on the same page, the numbering in FIG. 2, starts where the numbering in FIG. 1 ends.

The two drawings are arranged one over the other, and are aligned upon a time scale on the horizontal axis. The location of three time references used in the specification cross both drawings: T₀, T₁ and T₂.

### BACKGROUND OF THE INVENTION

This invention is a new process created from separate and independent existing processes. For the purpose of clarity, the following definitions are used and their best modes identified:

Educational Institution: The culinary program of an educational organization that is designed to produce a professional chef through formal education or apprenticeship. The best mode contemplated is an educational institution with a program that leads to a B.S. degree or its equivalent.

Business: A profit or non-profit, public or private business with food service operations which requires at least one Chef. The best modes contemplated are businesses that operate restaurants, hotels and banquet halls.

Executive Chef: The person in charge of all activities related to food service operations, which includes, menu creation, management of kitchen staff, wait staff, ordering and purchasing of inventory, plating design, budget, accounting and ultimately the profit and loss of food service operations.

The prior art to become an Executive Chef begins with either an apprenticeship or a formal education at an educational institution, followed by a random cycle of seeking Chef jobs of increasing responsibility in order to acquire the necessary experience. The food service industry has dealt with the uncertainty of the knowledge and skills imparted by the prior art by requiring an average of twenty (20) years experience for the position of Executive Chef as shown by the non-patent literature references listed in the IDS: #1) F. Villeneuve (2011, May), #2) E. Bell (2010, June), #3) K. Martinelli (2009, April), and #4) H. Sperling (2008, May).

The prior art in the form of the process that educational institutions use, cannot impart the actual real world job experience required for senior level positions. This is commonly accepted knowledge and is evidenced by salaries that are based upon the experience in this, as well as any other field.

The reason the prior art cannot solve this problem is that it is a number of disparate processes involving a minimum of three (3) different entities with different goals and objectives. Specifically, i) educational institutions are in the business of selling knowledge and skills to students in the form of education and training. ii) Businesses want the lowest cost individual that will perform their required business function. Individuals want the highest pay they can attain for the knowledge and skills they have paid to acquire.

Some educational institutions attempt to provide the opportunity for student internships. Other educational institutions operate restaurants open to the public. However these are not the same kind of real world experience that a business dependent upon its food service operations would provide. Other educational institutions attempt to address this deficiency by requiring a number of years of job experience to enter a program. However, this is not sufficient to provide the depth, breadth or kind of experience that other businesses recognize as sufficient to hire a graduate as an Executive Chef. This evidenced by the average of twenty (20) years of experience required by the industry for the position of Executive Chef, shown in the references indicated in paragraph [0008].

The process of the prior art is shown in FIG. 1 where a student completes their education (1) and begins their search for a Chefs job (2). Upon finding such a position (3), the individuals works in it acquiring sufficient to seek a position of increased responsibility. Those individuals wishing to become Executive Chefs will eventually seek the position (4). Until they have acquired the necessary experience, they will be unsuccessful (5) and must seek further Chef positions of increasing responsibility in order to acquire that experience. The cycle of (2) through (5) repeats itself until the individual acquires the experience deemed necessary for the position of Executive Chef (6). It is a process that requires the double coincidence of chance of the individual seeking the position of increased responsibility for which they are qualified, and a business seeking such an individual at the same time. It is a process that takes an average of twenty years as described in paragraph [0008], and is shown FIG. 1 by the time between T₀ and T₂.

The root cause of the inability to provide the knowledge and experience necessary to become an Executive Chef is that educational institutions do not have actual businesses in which to train their students to become an Executive Chef. All educational institutions have this problem because of the amount of the resources required to create such a business, as well as the many different disciplines required that are beyond the scope of an Executive Chef as described in paragraph [0007].

Unlike a general degree, the Executive Chef is a specialized function requiring a combination of vocational training, academic education, and real world experience that the industry will recognize as such.

### SUMMARY OF INVENTION

This invention is a new process created from existing well established and independent business and educational processes. Specifically, this invention creates a new educational structure by the business giving the lease of its food service operations to an educational institution which then runs them as extensions of its educational program. This invention turns businesses into the training facilities of educational institutions.

The educational institution assumes the responsibility for the business's food service operations. The particulars of every business can vary, such as the type of food, target market, layout of the kitchen and dining operations, size and volume. However, these variations are all within the specialized function of running food service operations. Running food service operations is the function of an Executive Chef as described in paragraph [0007].

The educational institution supplies the Executive Chef instructors that, in conjunction with the business, agree to the business's objectives and parameters for the business's food service operations including, but not limited to, budget, profits, service, quality and categories of food, as well as the number and functions of Executive Chef trainee slots at that business. Initially these slots are the Chef and sub-Chef positions that the business already has. This will change over time as business demands change, such as increased business requiring more chefs.

Because every business will differ in size, volume and target market, the specific parameters of its food service function will necessarily be different. However, the function of Executive Chef is the same. The particular business objectives for a business's food service operations are the real world requirements with which the educational institution trains their students.

The number of Chefs and sub-Chefs, and therefore the number of possible Executive Chef trainee slots, their duration, and the experience they provide at any particular business will necessarily depend upon the business's size and complexity. Specifically, not all businesses are large enough to have 20 chefs, 30 sub chefs and their supporting staff. Nor do all businesses cater several banquets of over 300 people on a weekly basis. However, it is the progression through the different slots in the different businesses of its program, in sequence of increasing responsibility that provides the individual the cumulative depth and breadth of experience required for the position of Executive Chef.

This invention permits the adaptation of the curriculum to the experience of the individual. For example, an Executive Chef Trainee with three (3) years work experience in a business that caters banquets, and has been the Chef in charge of more than 100 banquets of more than 500 people, can demonstrate that experience to the Executive Chef instructor by being in the slot at a business that provides banquets for just a couple banquets. The Executive Chef Trainee then need not complete a full rotation in that slot as it would be redundant. In this manner the length of the program for each individual may differ based upon their prior work experience.

The number of slots at each particular business are the number of Chefs the business had before the implementation of this invention, as described in paragraphs [0017] and [0019]. The businesses pay the salaries of the Chefs with or without this invention. This invention turns the positions of the particular Chefs and sub-Chefs into training slots. The educational institution schedules Executive Chef Trainees with the corresponding experience to fill these slots when the previous Executive Chef Trainee in that slot moves to the next slot.

This invention is shown in FIG. 2 where the student completes the normal curriculum of the educational institution (7) and enters the working slots of the program going through the necessary slots in sequence (8). The last slot (9) is where the student functions as the Executive Chef of the business. The business still verifies that the Executive Chef Trainee in the last slot is meeting the business objectives agreed to by the educational institution and the business. The business has the added assurance that the Executive Chef Trainee is being supervised by the Executive Chef instructor. After going through the program, the student graduates with the training and the actual job experience of functioning as the Executive Chef of a real business (10).

By creating a new educational structure that eliminates the requirement of the double coincidence of job availability and job search from the process of acquiring the knowledge and real world experience required for the position of Executive Chef, this invention shortens the time required to acquire that experience as shown in FIG. 2 as the time between T₀ and T₁.

What is claimed is:

1. The creation of an educational structure by a business arrangement between one or more businesses and an educational institution where the educational institution runs the food service operations for the business or businesses where each business and the educational institution both agree to the particular business's objectives and parameters for the business's food service operations.

2. The educational structure of claim 1 where the educational institution defines the number and function of trainee slots at each business based upon the particulars of the business. Specifically, a particular business's Chef and sub-Chef positions and functions become the initial trainee slots. The educational institution moves the trainees through the slots of the business or businesses in order of increasing responsibility.

3. The educational structure of claim 2, where the time in the program is shortened to reduce the redundancy of the particular trainee's specific work experience as Chef or sub-Chef.

4. The educational structure of claim 2 where the final trainee slot is the function of Executive Chef for the business.

5. The educational structure of claim 3 where the final trainee slot is the function of Executive Chef for the business.
